(19) United States
(12) Patent Application Publication
(10) Pub. No.: US 2009/0121991 A1
(43) Pub. Date: May 14, 2009

(54) Array Substrate and Liquid Crystal Display

(76) Inventors: Te-Chen Chung, Kun Shan (CN); Tean-Sen Jen, Kun Shan (CN)

Correspondence Address: Nixon Peabody LLP, 200 Page Mill Road, Suite 200, Palo Alto, CA, 94306, US

(21) Appl. No.: 12/180,564

(22) Filed: Jul. 28, 2008

(30) Foreign Application Priority Data
Nov. 12, 2007 (CN) 200710170343.2

(51) Int. Cl. G09G 3/36

(52) U.S. Cl. 345/87

(57) ABSTRACT

An array substrate of liquid crystal display having a novel pixel structure comprises data lines; scanning lines, the scanning lines and the data lines being arranged across each other and defining a number of pixel regions; a dielectric layer disposed on the scanning lines; pixel electrodes in the pixel regions; storage capacitor electrode lines for forming storage capacitors together with the pixel electrodes, and a conductive section disposed on the dielectric layer above a part of a scanning line that corresponds to a pixel region and in electrical communication with the storage capacitor electrode lines. According to the invention, the disposition of a conduction section can significantly reduce the electric field effect between scanning lines and common transparent electrodes. The invention can decrease the inductive electric charge, avoid the influence of the inductive electric charge on the arrangement of liquid crystal molecules, and thus markedly improve the display quality.

### TECHNICAL FIELD

The invention relates to a liquid crystal display, and in particular, to an array substrate of a liquid crystal display.

### BACKGROUND

Liquid crystal displays (LCDs) are widely utilized in modern information devices such as notebook computers, cellular phones, personal digital assistants (PDAs) and the like, since they are advantageous in being light, thin and having low power consumption.

FIG. 1 shows a schematic diagram of a pixel structure in a conventional liquid crystal display (LCD). For clarity, only the structure at an array substrate side is illustrated, whereas the configuration at a liquid crystal layer and a color filter side is omitted. A reference number 11 represents a scanning line, and a reference number 12 represents a data line. A number of scanning lines are arranged across a number of data lines to define a number of pixel regions, and Thin Film Transistors (TFTs) are disposed nearby the corresponding crossing points of the scanning lines and the data lines. Each of the TFTs consists of a source electrode 121, a drain electrode 14 and a gate electrode, wherein the source electrode 121 is electrically connected to the data line 12, the drain electrode 14 is electrically connected to a pixel electrode 16 via a through-hole 15 and the gate electrode is electrically connected to the scanning line 11 (as shown in FIG. 1, the gate electrode is actually a part of the scanning line). A reference number 13 represents a storage capacitor electrode line, which functions to form a storage capacitor together with the pixel electrode 16 so as to hold the voltage applied to the pixel electrode. A reference number 131 represents an extending part of the storage capacitor electrode line extending along the direction of the data line within the pixel region, which can increase the storage capacitor capacitance and meanwhile shield the mutual influence of the electric fields between the pixel electrodes and the data lines.

In the operation of the LCD, a data signal is transmitted from the data line 12 to the pixel electrode 16 under the control of the ON/OFF status of the TFT, and the voltage on the pixel electrode 16 is held by the storage capacitor. As shown in FIG. 1, two pixel electrodes 16 and 16′ arranged along the direction of the data line are separated by the scanning line 11. In general, voltages applied to adjacent pixel electrodes are different, and thereby the electric field effect occurs between the adjacent pixel electrodes.

FIG. 2 is a cross sectional view of FIG. 1 taken along the I-I direction. Also for clarity, only the arrangements at the color filter side and the array substrate side are illustrated, whereas the arrangement at the liquid crystal layer side is omitted. A reference number 101 indicates a lower glass substrate. The scanning line 11 is disposed on the lower glass substrate, a gate insulation film 102 and a passivation layer 103 are in turn disposed on the scanning line, the pixel electrode 16 is disposed on the passivation layer 103 (please note that there is no pixel electrode right above the scanning line) and a first alignment film 104 is disposed above the passivation layer 103 and the pixel electrode 16. Below an upper glass substrate 108 opposite to the lower glass substrate, there are disposed a plurality of color filter sections 107 and light shield sections 109, Below the color filter sections 107 and light shied sections 109, a common transparent electrode 106 and a second alignment film 105 are disposed in turn. In general, when the LCD operates, an inductive charge 17 is generated on the first alignment film 104 right above the scanning line. The inductive charge mainly comprises two parts, i.e. the charge generated due to the electric field effect between the adjacent pixel electrodes 16 and 16′, and the charge caused by the voltage difference between the scanning line 11 and the common transparent electrode 106. Please note that the inductive charge shown as a positive charge is only an example of the inductive charge, actually the inductive charge 17 may also be a negative charge and the polarity of the inductive charge depends on the direction of the electric field causing the inductive charge. In addition, the cases in other figures of the invention are the same as that in FIG. 2, wherein the inductive charge is shown as a positive charge only for purpose of illustration and the inductive charge may also be a negative charge.

Normally, the inductive charge has little influence on the display quality. However, when the pixel electrode maintains the status as shown in FIG. 3A for a long time due to a certain display requirement, the quality of sequent display frames may suffer influence from the inductive charge. Specifically, in FIG. 3A, the pixel above the scanning line 11 is displayed with a high gray scale and the voltage on the pixel electrode 16′ is a low voltage, while the pixel below the scanning line 11 is displayed with a low gray scale and the voltage on the pixel electrode 16 is a high voltage. Therefore, the inductive charge 17 caused by the electric field effect existing between the pixel electrodes 16 and 16′ is distributed above the scanning line 11 between the pixel electrodes 16 and 16′. Because the voltage on pixel electrode 16 is higher than that on pixel electrode 16′, the amount of the inductive charge close to the pixel electrode 16 is larger than that of the inductive charge close to the pixel electrode 16′. Further, an arrow 19 schematically represents a frictional direction of the alignment film. After being aligned by friction, liquid crystal molecules are arranged in accordance with a predetermined direction and pre-tilted angles are formed between the liquid crystal molecules and a surface of the alignment film.

FIG. 3B is a cross sectional view of FIG. 3A taken along the I-I direction. Also for clarity, only the arrangements at the color filter side and the array substrate side, and one layer of liquid crystal molecules 18 influenced by the inductive charge 17 are illustrated. The scanning line 11 is disposed on the lower glass substrate 101, the gate insulation film 102 and the passivation layer 103 are in turn disposed on the scanning line, the pixel electrodes 16 and 16′ are disposed on the passivation layer 103 and a first alignment film 104 is disposed above pixel electrodes 16 and 16′ and the passivation layer 103. Below the upper glass substrate 108 opposite to the lower glass substrate 101, there are disposed a plurality of color filter sections 107 and light shield sections 109, and a common transparent electrode 106 and a second alignment film 105 disposed in turn beneath.

As described above, an inductive charge is generated above the scanning line 11 between the adjacent pixel electrodes 16 and 16′ due to the electric field effect existing between the adjacent pixel electrodes 16 and 16′. Additionally, when the liquid crystal display is in operation, the voltage on the scanning line 11 often ranges from −6V to −10V, while the voltage on the common transparent electrode 106 is about +4.5 V. Then there is a large voltage difference between the scanning line 11 and the common transparent electrode 106, the largest voltage difference being even close to 14.5V, thus a large electric field is formed therebetween and a large inductive charge is generated. So the inductive charge 17 is distributed on the first alignment film 104 right above the scanning line, and as described above, the amount of the inductive charge close to the pixel electrode 16 is relatively larger. Additionally, after the process of aligning, the first alignment film 104 makes the liquid crystal molecules 18 arranged in a certain direction and pre-tilted angles are formed between the liquid crystal molecules 18 and the glass substrate.

Please note that the presence of the inductive charge 17 causes an electric field to be formed between the inductive charge 17 and the pixel electrode so as to influence the arrangement of the liquid crystal molecules and change the pre-tilted angles of the liquid crystal molecules. As illustrated in FIG. 3B, the arrangement of liquid crystal molecules will be influenced at any position having an inductive charge (please note that for simplification, only the influence of the inductive charge on the liquid crystal molecules close to the pixel electrode 16 is illustrated), while the inductive charge at the position close to the pixel electrode 16 are of the largest amount and thus producing the highest electric field. Under the action of the electric field, the pre-tilted angles of the liquid crystal molecules 18′ nearby the pixel electrode 16 are increased, which results in display defects such as light leaking. As illustrated in FIG. 3C, when the display status of the pixel electrodes 16 and 16′ changes from the status as shown in FIG. 3A to the status of a medium gray scale, light leaking occurs at a partial region 31 of the pixel electrode 16 close to the scanning line and thus the display quality becomes deteriorated.

### SUMMARY OF THE INVENTION

An array substrate of liquid crystal display having a novel pixel structure is provided in an embodiment of the invention so as to improve display quality that would have otherwise deteriorated due to the influence of the inductive charge. The array substrate of liquid crystal display comprises data lines; scanning lines, the scanning lines and the data lines being arranged across each other and defining a number of pixel regions, and a dielectric layer being disposed on the scanning lines; pixel electrodes placed in the pixel regions; storage capacitor electrode lines for forming storage capacitors together with the pixel electrodes, and a conductive section disposed on the dielectric layer above a part of a scanning lines that corresponds to a pixel region and in electrical communication with the storage capacitor electrode lines.

In the above array substrate of liquid crystal display, if desired, the conductive section can be disposed on the dielectric layer above the part of the scanning lines that corresponds to all or most of the pixel regions and in electrical communication with the storage capacitor electrode lines. Also, the conductive section extends along the direction of scanning lines, and the size of the conductive section is fitted to the size of the part of the scanning lines that corresponds to one pixel region.

According to an embodiment of the invention, due to the disposition of an electrical conduction section, the electric field effect between scanning lines and common transparent electrodes can be shielded. Meanwhile, since the conductive section is in electrical communication with the storage capacitor electrode lines receiving a common voltage, both the conductive section and the common transparent electrode have the same electric potential. Accordingly, the invention can significantly suppress the electric field effect, reduce the generated inductive charge, avoid the influence of the inductive charge on the arrangement of liquid crystal molecules, and thus markedly improve the display quality.

Additionally, an improved structure is also provided in an embodiment of the invention to overcome the problems of image flicker and sticking that may arise after the disposition of the conductive section above scanning lines. That is, in the array substrate of liquid crystal display, an auxiliary conductive layer is formed above a plurality of scanning signal introducing lines used to connect with scanning lines and introduce scanning signals, in order to form an auxiliary capacitor with plurality of scanning signal introducing lines. The auxiliary capacitor causes most loads on the scanning lines to be carried by the scanning signal introducing lines, and thus suppresses the influence of the feed through effect on display frames thereby improving the display quality.

### BRIEF DESCRIPTION OF THE DRAWINGS

From the following detailed description to the embodiments, accompanying with the drawings, the present invention will be more apparent. In the drawings,

FIG. 1 is a schematic diagram of a pixel structure at an array substrate side of a conventional LCD;

FIG. 2 is a cross sectional view of FIG. 1 taken along the I-I direction;

FIG. 3A is a schematic diagram that shows an exemplary operation status of a pixel electrode in a LCD;

FIG. 3B is a cross sectional view of FIG. 3A taken along the I-I direction;

FIG. 3C is a schematic diagram that shows another exemplary operation status of the pixel electrode in the LCD;

FIG. 4A is a schematic diagram of a pixel structure at an array substrate side of the LCD according to an embodiment of the invention;

FIG. 4B is a cross sectional view of FIG. 4A taken along the II-II direction;

FIG. 4C is a cross sectional view of FIG. 4A taken along the III-III direction;

FIG. 5A is a schematic diagram that illustrates the influence on feed-through voltages ΔVp of pixel electrodes by RC delay of scanning signals;

FIG. 5B is a schematic graph that illustrates change for feed-through voltages ΔVp of the pixel electrodes caused by RC delay of scanning signals along the direction of a scanning line;

FIG. 6A is an overall schematic diagram of an LCD panel according to an embodiment of the invention;

FIG. 6B is a partly enlarged diagram of the scanning line connection region 56 in FIG. 6A;

FIG. 6C is a cross sectional view of FIG. 6B taken along the IV-IV direction; and

FIG. 7 is a schematic contrast diagram of the changes for feed-through voltages ΔVp of the pixel electrodes along the direction of a scanning line before and after the disposition of an auxiliary conductive layer above scanning signal introducing lines.

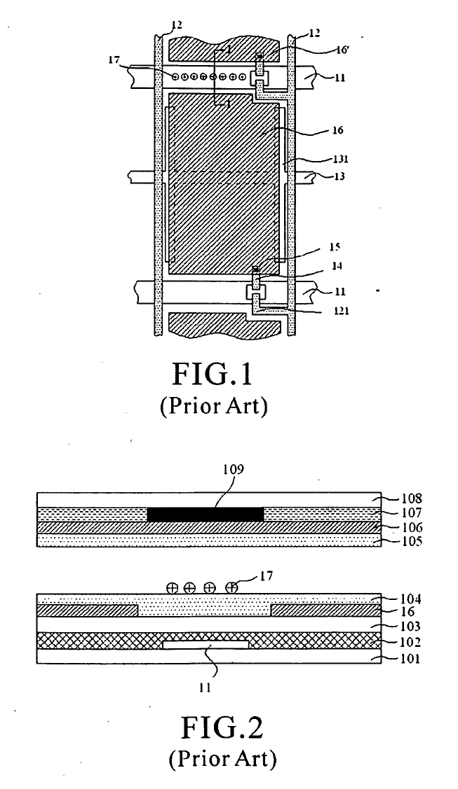

### DETAILED DESCRIPTION OF EMBODIMENTS

Below, exemplary embodiments of the invention will be described in detail with reference to the drawings.

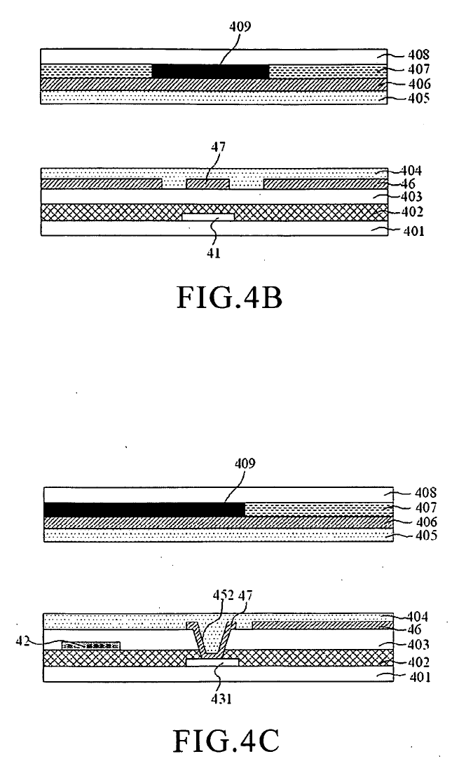

FIG. 4A shows a schematic diagram of a pixel structure in a liquid crystal display according to an embodiment of the invention. For clarity, only the pixel structure at an array substrate side is illustrated, whereas the configuration at a liquid crystal layer and a color filter side is omitted. A reference number 41 represents a scanning line, and a reference number 42 represents a data line. A number of scanning lines are arranged across a number of data lines to define a number of pixel regions, and Thin Film Transistors (TFT) are disposed nearby the crossing points of the individual scanning lines and the data lines. Each of the TFTs comprises a source electrode 421, a drain electrode 44 and a gate electrode. The source electrode 421 is electrically connected to the data line 42, the drain electrode 44 is electrically connected to a pixel electrode 46 via a first through-hole 451, and the gate electrode is electrically connected to the scanning line 41 (as shown in FIG. 4A, the gate electrode is actually a part of the scanning line 41). A reference number 43 represents a storage capacitor electrode line, which functions to form a storage capacitor with the pixel electrode 46 so as to hold the voltage applied to the pixel electrode. A reference number 431 represents an extending part of the storage capacitor electrode line extending along the data line within the pixel region, which can increase the storage capacitor capacitance and meanwhile shield the influence of the electric field between the pixel electrode and the data line.

In the pixel structure of the LCD of the embodiment of the invention, a conductive section 47 is provided above a part of the scanning line 41 that corresponds to a pixel region. The conductive section 47 extends along the direction of the scanning line and is electrically connected to the storage capacitor electrode line extending part 431 via a second through-hole 452. Thus, electric signals on the storage capacitor electrode line 43 can be transmitted to the conductive section 47 via the second through-hole 452. In the embodiment of the invention, the conductive section 47 is preferably a thin conductive layer formed by Indium Tin Oxide (ITO). However, the conductive section 47 is not limited to the structure of the thin conductive layer, but can be of other structures and formed by other conductive materials. Additionally, as illustrated in FIG. 4A, the storage capacitor electrode line extending part 431 corresponding to one pixel electrode 46 can be connected to the conductive sections 47 above the upper and lower scanning lines 41 respectively via two second through-holes 452. In order to be connected to the storage capacitor electrode line extending part, the conductive sections 47 have a portion extending along the direction of the data line, but it is noted that such a portion is only for connection and the main body of the conductive section still extends along the direction of the scanning lines.

Also, it is noted that the above connection manner is merely exemplary and the conductive section 47 can be connected with the storage capacitor electrode line extending part 431 in any other manner. For instance, the storage capacitor electrode line extending part 431 can be only connected to the conductive section above one of the scanning lines via the second through-hole. In other words, the connection techniques are not limited to the manner as shown in FIG. 4A, as long as the conductive section 47 is electrically connected to the storage capacitor electrode line extending part 431, i.e., as long as the conductive section 47 is electrically connected to the storage capacitor electrode line 43. In addition, any connection technique other than connection via a through-hole can also be used.

FIG. 4B is a cross sectional view of FIG. 4A taken along the II-II direction. Also for clarity, only the arrangements at the color filter side and the array substrate side are illustrated, and the arrangement of the liquid crystal layer is omitted. The scanning line 41 is disposed on the lower glass substrate 401, the gate insulation film 402 and the passivation layer 403 are in turn disposed on the scanning line 41, the pixel electrode 46 is disposed on the passivation layer 403, the conductive section 47 is provided above the scanning line 41 and a first alignment film 404 is disposed on top. Below the upper glass substrate 408 opposite to the lower glass substrate, there are disposed a plurality of color filter sections 407 and light shield sections 409, and then disposed further below a common transparent electrode 406 and a second alignment film 405 in turn. In the embodiment, the conductive section 47 is disposed on the passivation layer 403 and made of the same materials (e.g. a transparent conductive material ITO) within the same manufacturing process as the pixel electrode 46. However, the conductive section 47 can be made of other materials and also be disposed on other layers above the scanning line 41, as long as the conductive section 47 is not in electrical communication with the scanning line 41. For instance, the conductive section 47 can be disposed on the gate insulation film 402.

FIG. 4C is a cross sectional view of FIG. 4A taken along the III-III direction. Also, only the arrangements at the color filter side and the array substrate side are illustrated, and the arrangement of the liquid crystal layer is omitted. The second through-hole 452 penetrates the passivation layer 403 and the gate insulation film 402, so that the conductive section 47 can be electrically connected to the storage capacitor electrode line extending part 431 via the second through-hole 452. In the embodiment, the second through-hole 452 and the first through-hole 451 are made in the same manufacturing process.

In the embodiment of the invention, the conductive section 47 is disposed above the scanning line 41, so the electric field between the scanning line 41 and the common transparent electrode 406 is shielded. As shown in FIG. 4B, the size of the conductive section 47 is fitted to the size of the part of the scanning line 41 corresponding to the pixel region, that is, the conductive section 47 should cover the part of the scanning line corresponding to the pixel region as large as possible, so as to shield the electric field between the scanning line 41 and the common transparent electrode 406 to the greatest extent. In addition, since the conductive section 47 and the storage capacitor electrode line extending part 431 are in electrical communication with each other, the voltages of the conductive section 47 and the storage capacitor electrode line 43 are the same. Conventionally, the voltage of the storage capacitor electrode line 43 is usually about +4.5V, and the voltage of the common transparent electrode 406 is also about +4.5 V. Since the conductive section 47 and the common transparent electrode 406 are substantially of the same electric potential, the electric field effect between them will not be obvious and the generated inductive charge is greatly reduced. Therefore, the influence on the arrangement of liquid crystal molecules by the inductive charge would be significantly reduced, the phenomenon of light leakage can be suppressed and thus the display quality can be greatly improved.

However, in the pixel arrangement shown in FIG. 4A according to an embodiment of the invention, a large parasitic capacitor would be formed between the conductive section 47 and the scanning line 41 due to the presence of the conductive section 47, so the wiring capacitance on the scanning line 41 would be increased and thereby a relatively large delay of scanning signals would be generated.

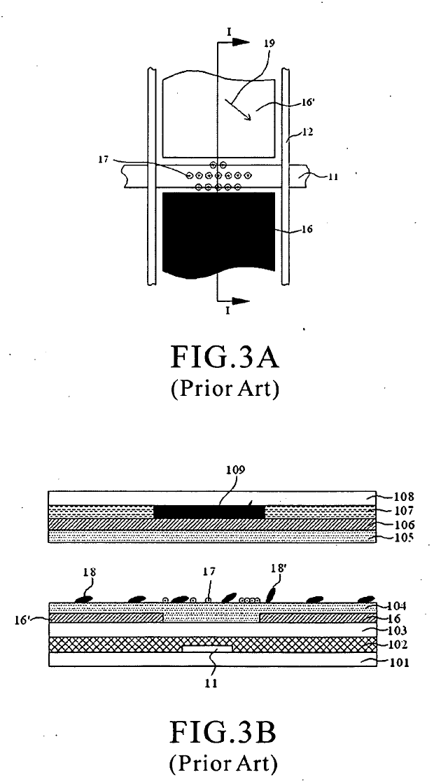

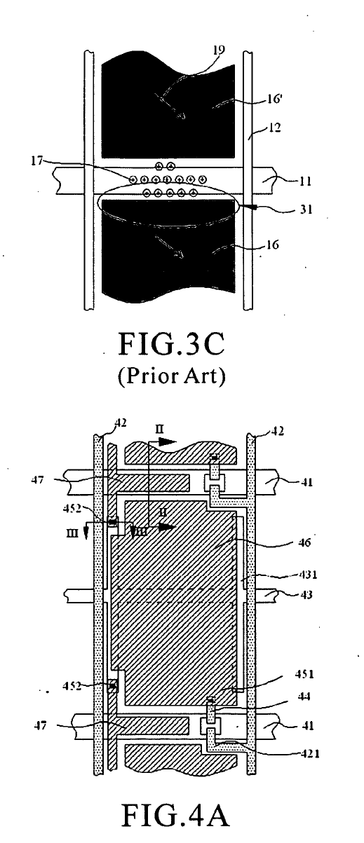

In particular, because actually each of the scanning lines has certain wiring resistance and capacitance, scanning signals would be subjected to the influence from the resistance-capacitance (RC) effect of the scanning line and the waveforms of the scanning signals would be changed, which is commonly referred as the delay of scanning signals. As illustrated in FIG. 3B, in the structure having no conductive section 47 provided, the wiring capacitance of the scanning line 11 mainly comprises the parasitic capacitor formed between the scanning line 11 and the common transparent electrode 106 opposite thereto, which can be regarded as a series connection of a first capacitor C1 formed by the gate insulation layer 102 and the passivation layer 103 and a second capacitor C2 formed by the first and the second alignment films 104 and 105 and the liquid crystal layer.

As shown in FIG. 4B, the conductive section 47 is provided above the scanning line 41 and as described above, the conductive section 47 and the common transparent electrode 406 are of almost the same electric potential. Thus, in this case, the electric field between the scanning line 41 and the common transparent electrode 406 can be shielded, and thereby the wiring capacitor of the scanning line 41 mainly comprises the parasitic capacitor between the scanning line 41 and the conductive section 47. The parasitic capacitor between the scanning line 41 and the conductive section 47 mainly comprises the first capacitor C1 formed by the gate insulation layer 402 and the passivation layer 403 (actually the gate insulation layer 102 and the passivation layer 103 as shown in FIG. 3B). Since the conductive section 47 is electrically connected to the storage capacitor electrode line and the storage capacitor electrode lines are usually in electrical communication with one another, the parallel connection capacitor Cs′ of the storage capacitors Cs corresponding to each of the pixel electrodes in the entire LCD panel would influence the wiring capacitor of the scanning line 41 through the conductive section 47. Also, the capacitors C1′ between the other conductive sections in electrical communication with the conductive section 47 and the corresponding scanning lines would influence the wiring capacitor of the scanning line 41 through the conductive section 47. However, since the influence of the above-described Cs′ and C1′ on the wiring capacitor of the scanning line 41 is much less than that of C1, the wiring capacitor of the scanning line 41 is approximately C1.

Based on the above analysis, it can be seen that after the conductive section 47 is disposed above the scanning line, the wiring capacitance of the scanning line would be increased (the capacitance of the first capacitor C1 is certainly larger than that of the series connection of the first capacitor C1 and the second capacitor C2). A larger delay of scanning signals would be generated and thus display defects such as image flicker or image sticking would arise. In order to overcome such display defects, an improved structure of the LCD panel will be provided in the embodiment of the invention. First, the display defects caused by the delay of scanning signals will be illustrated in connection with the concept of a feed through voltage ΔVp.

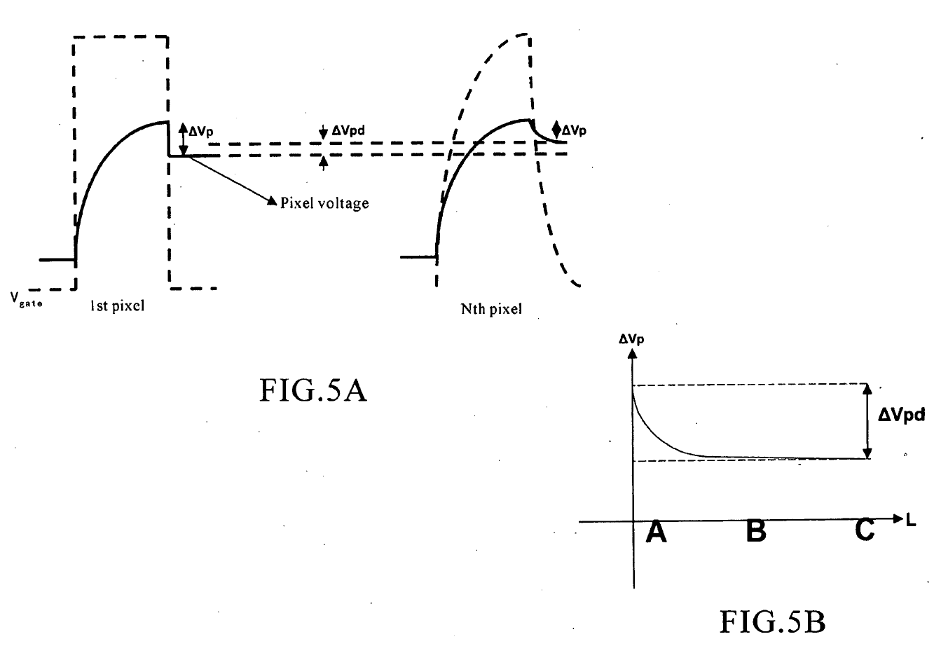

As shown in FIG. 5A, because the thin film transistor (TFT) connected to the pixel electrode has a so-called feed through effect, at the moment of completion of the scanning signal (i.e. when the gate electrode of the TFT is turned off), the electric potential of the pixel electrode would be decreased, and thus there is a potential difference for the pixel electrode before and after the TFT is turned off, which is referred to the feed through voltage ΔVp. Due to the presence of the feed through voltage ΔVp, the LCD panel has different light penetration ratios and different luminance before and after the TFT is turned off. Thus image flicker occurs and the display quality of the LCD panel would be deteriorated. On the other hand, because of the RC delay on the scanning lines, the scanning signals being received by the pixel electrodes that are connected to a same scanning line would be different from one another. As depicted in FIG. 5A, on the same scanning line, the feed through voltages ΔVp of the latter pixel electrodes (such as the pixel electrode corresponding to the Nth pixel) are smaller than those of the former pixel electrodes (such as the pixel electrode corresponding to the first pixel), so there exists a certain feed through voltage difference ΔVpd, which results in the problem of image sticking on the LCD panel.

FIG. 5B is a schematic graph that illustrates change for ΔVp of the pixel electrode caused by the RC delay of scanning signals along the direction of a scanning line. As illustrated in FIG. 5B, with A, B and C representing three points along the direction of the scanning line, it can be seen that the change of ΔVp between the former pixel electrodes (from A to B) is obvious, but such change is gradually reduced along the direction of the scanning line, and thus the change of ΔVp between the latter pixel electrodes (from B to C) is very slight.

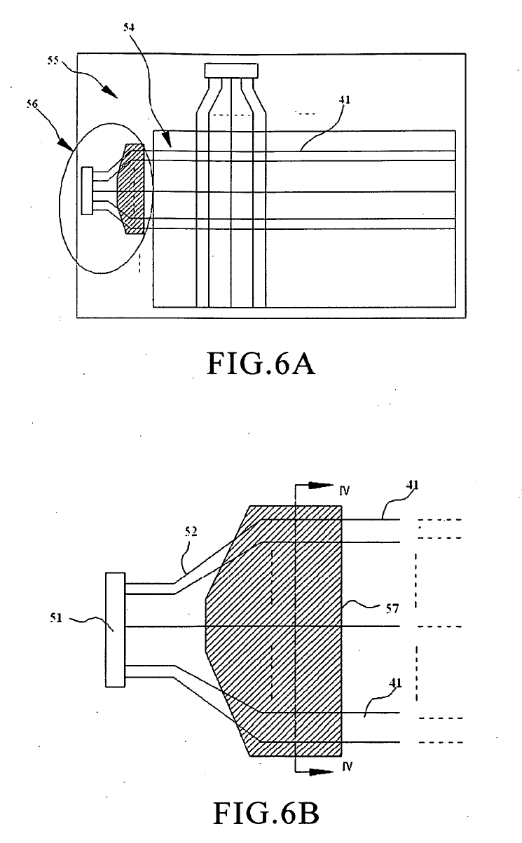

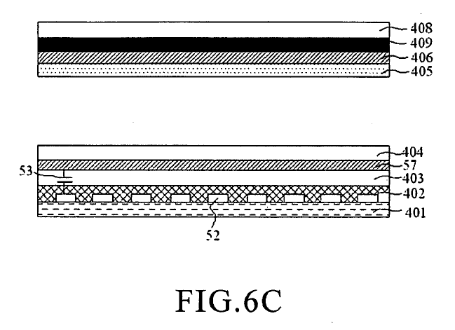

The improved structure of the LCD panel according to an embodiment of invention for solving the problem resulted from the above LCD panel structure will be described as follows. The improvement is to provide an auxiliary conductive layer in electrical communication with the storage capacitor electrode line 43 in the scanning signal introducing region, as shown in FIG. 6A.

FIG. 6A is an overall schematic diagram of the LCD panel. For clarity, the structure at the side of the liquid crystal layer and the color filter is omitted, and only the overall structure at the array substrate side is illustrated. A reference number 54 indicates a display region, and a reference number 55 indicates a non-display region. FIG. 6B is a partly enlarged diagram of the scanning signal introducing region 56 in FIG. 6A, wherein a reference number 51 indicates a terminal for receiving scanning signals, a reference number 52 indicates a scanning signal introducing line. One terminal of the scanning signal introducing line 52 is connected to the terminal 51 for receiving scanning signals, and the other terminal thereof is connected to the scanning line 41. Thus, scanning signals are received by the terminal 51 for receiving scanning signals, and then transmitted to the scanning line 41 via the scanning signal introducing line 52.

As shown in FIG. 6B, considering a number of the scanning signal introducing lines 52 as a whole section, an auxiliary conductive layer 57 is disposed above the section and the auxiliary conductive layer 57 is in electrical communication with the storage capacitor electrode line 43. In an embodiment, the auxiliary conductive layer 57 is electrically connected to the storage capacitor electrode line extending part 431 or the storage capacitor electrode line 43 via a through-hole. Moreover, the auxiliary conductive layer 57 can have a shape fitted in accordance with the wiring lengths of the scanning signal introducing lines 52, so as to assure the capacitance value of the auxiliary capacitor formed by the auxiliary conductive layer 57 and each of the scanning signal introducing lines 52 is almost equal to one another. As shown in FIG. 6B, the scanning signal introducing lines 52 are arranged as a sector. Since the scanning signal introducing lines at both sides are longer than those at the middle region, the shape of the auxiliary conductive layer can be designed as “ [symbol] ”, “ [symbol] ” or the like to make sure that the capacitance value of the auxiliary capacitor for each scanning signal introducing line is almost same.

FIG. 6C is a cross sectional view of FIG. 6B taken along the IV-IV direction, wherein the scanning signal introducing lines 52 are disposed on the lower glass substrate 401, and the gate insulation film 402, the passivation layer 403, the auxiliary conductive layer 57 and the first alignment film 404 are in turn disposed on the scanning signal introducing lines. Below the upper glass substrate 408 opposite to the lower glass substrate, there are disposed a plurality of light shield sections 409, a common transparent electrode 406 and a second alignment film 405 in turn. In the embodiment, the auxiliary conductive layer 57 can be made of transparent conductive materials and preferably disposed on the passivation layer 403. However, it is noted that the auxiliary conductive layer 57 can be made of other materials and disposed on the other layers above the scanning signal introducing lines 52 (e.g. the auxiliary conductive layer 57 can be disposed on the gate insulation film 402), as long as the auxiliary conductive layer 57 is not in electrical communication with the scanning signal introducing lines 52. An auxiliary capacitor 53 can be formed between the auxiliary conductive layer 57 and the scanning signal introducing lines 52.

Similar to the principle of the wiring capacitance on the scanning line being increased after the conductive section 47 is disposed above the scanning line and electrically connected to the storage capacitor electrode line as described above with reference to FIG. 4B, the wiring capacitance on the scanning signal introducing lines 52 will be increased when the auxiliary conductive layer 57 is disposed above the scanning signal introducing lines 52 and electrically connected to the storage capacitor lines.

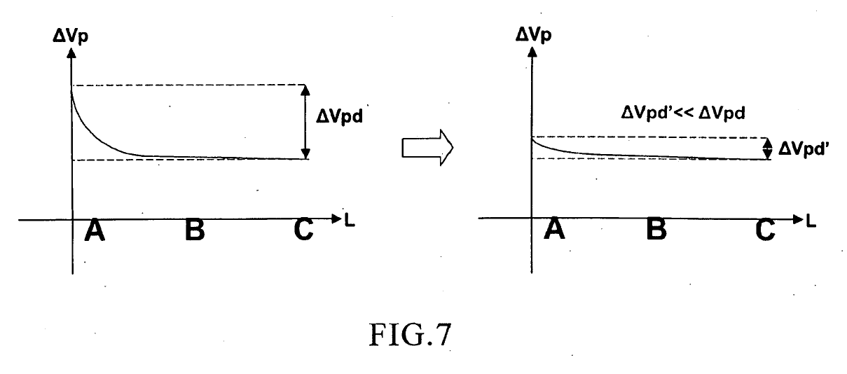

FIG. 7 is a schematic contrast diagram of the change for ΔVp of the pixel electrode along the direction of a scanning line before and after the disposition of an auxiliary conductive layer above the scanning signal introducing lines. The left is a graph indicating the change for ΔVp of the pixel electrode along the direction of the scanning line before the disposition of the auxiliary conductive layer, and the right is a graph indicating the changes for ΔVp of the pixel electrode along the direction of the scanning line after the disposition of the auxiliary conductive layer. The wiring capacitance on the scanning signal introducing lines is increased due to the disposition of the auxiliary conductive layer, then most loads on the scanning lines are carried by the scanning signal introducing lines 52, and thus the ΔVp of the pixel electrode is relatively low from the beginning part of the scanning line and the change ΔVpd of ΔVp along the direction of the scanning line is very low. Because of the reduced ΔVp and ΔVpd, the phenomenon of image flicker and sticking on the LCD panel can be suppressed.

Embodiments have been described to illustrate the principles and implementation of the invention, however the description is only for the purpose of explanation of the spirits and ideas of the invention, but not to limit the scope of the invention. Meanwhile, various modifications and alternatives to the above embodiment within the scope of the invention are apparent for those skilled in the art, as long as such modifications and alternatives are falling into the scope as defined by the appended claims and the equivalents thereof.

What is claimed is:

1. An array substrate of liquid crystal display, comprising:
data lines;
scanning lines, the scanning lines and the data lines being arranged across each other to define a plurality of pixel regions, and a dielectric layer being disposed on the scanning lines;
pixel electrodes placed in the pixel regions;
storage capacitor electrode lines for forming storage capacitors together with the pixel electrodes; and
a conductive section disposed on the dielectric layer above a part of a scanning line corresponding to a pixel region and in electrical communication with the storage capacitor electrode lines.

2. The array substrate of liquid crystal display according to claim 1, wherein the conductive section comprises a main body extending along the direction of the scanning lines.

3. The array substrate of liquid crystal display according to claim 2, wherein the size of the conductive section is fitted to the size of the part of the scanning line that corresponds to the pixel region.

4. The array substrate of liquid crystal display according to claim 1, wherein the dielectric layer comprises a gate insulation layer.

5. The array substrate of liquid crystal display according to claim 1, wherein the dielectric layer comprises a gate insulation layer and a passivation layer.

6. The array substrate of liquid crystal display according to claim 1, wherein the conductive section is made of the same material and formed in the same process as the pixel electrodes.

7. The array substrate of liquid crystal display according to claim 1, further comprising storage capacitor electrode line extending parts formed by the storage capacitor electrode lines extending along the direction of the data lines within the respective pixel regions, and the conductive section being electrically connected to at least one storage capacitor electrode line extending part closest thereto via at least one through-hole.

8. The array substrate of liquid crystal display according to claim 1, further comprising:
a plurality of scanning signal introducing lines, each of which having a terminal connected to a respective scanning line for introducing scanning signals into the scanning line, and
an auxiliary conductive layer disposed above the plurality of scanning signal introducing lines for forming auxiliary capacitors with the plurality of scanning signal introducing lines, and in electrical communication with the storage capacitor electrode lines.

9. The array substrate of liquid crystal display according to claim 8, wherein the shape of the auxiliary conductive layer is fitted to wiring lengths of the plurality of scanning signal introducing lines so that auxiliary capacitors formed by the auxiliary conductive layer and the corresponding scanning signal introducing lines have substantially equal capacitance values.

10. The array substrate of liquid crystal display according to claim 8, further comprising storage capacitor electrode line extending parts formed by the storage capacitor electrode lines extending along the direction of the data lines within the respective pixel regions, and the auxiliary conductive layer being electrically connected to the storage capacitor electrode line extending parts via a through-hole.

11. The array substrate of liquid crystal display according to claim 8, wherein the auxiliary conductive layer is made of the same material and is formed in the same process as the pixel electrodes.

12. A liquid crystal display comprising an array substrate, the array substrate comprising:
data lines;
scanning lines, the scanning lines and the data lines being arranged across each other to define a plurality of pixel regions;
a dielectric layer disposed on the scanning lines;
pixel electrodes in the pixel regions;
storage capacitor electrode lines for forming storage capacitors together with the pixel electrodes; and
a conductive section disposed on the dielectric layer above a part of a scanning line corresponding to a pixel region and in electrical communication with the storage capacitor electrode lines.

13. The liquid crystal display according to claim 12, wherein the conductive section comprises a main body extending along the direction of the scanning lines.

14. The liquid crystal display according to claim 12, wherein the dielectric layer comprises a gate insulation layer.

15. The liquid crystal display according to claim 12, wherein the dielectric layer comprises a gate insulation layer and a passivation layer.

16. The liquid crystal display according to claim 12, wherein the conductive section is made of the same material and formed in the same process as the pixel electrodes.

17. The liquid crystal display according to claim 12, wherein the storage capacitor electrode lines further comprise storage capacitor electrode lines extending parts extending along the direction of the data lines within the respective pixel regions, and the conductive section is electrically connected to at least one storage capacitor electrode line extending part closest thereto via at least one through-hole.

18. The liquid crystal display according to claim 12, further comprising:
a plurality of scanning signal introducing lines each having a terminal connected to a respective scanning line for introducing scanning signals into the scanning line, and
an auxiliary conductive layer disposed above the plurality of scanning signal introducing lines for forming auxiliary capacitors with the plurality of scanning signal introducing lines, and in electrical communication with the storage capacitor electrode lines.

19. The liquid crystal display according to claim 18, wherein the auxiliary conductive layer has a shape fitted to wiring lengths of the plurality of scanning signal introducing lines so that auxiliary capacitors formed by the auxiliary conductive layer and the corresponding scanning signal introducing lines have substantially equal capacitance values.

20. The liquid crystal display according to claim 18, wherein the storage capacitor electrode lines further comprise storage capacitor electrode line extending parts extending along the direction of the data lines within the respective pixel regions, and the auxiliary conductive layer is electrically connected to the storage capacitor electrode line extending parts via a through-hole.

21. The liquid crystal display according to claim 18, wherein the auxiliary conductive layer is made of the same material and formed in the same process as the pixel electrodes.
